(19) United States
(12) Patent Application Publication
(10) Pub. No.: US 2025/0060615 A1
(43) Pub. Date: Feb. 20, 2025

(54) LIGHTWEIGHT INDUSTRIAL EYEGLASS STRUCTURE

(71) Applicant: OURAD SAFETY CO., LTD., TAINAN CITY (TW)

(72) Inventor: PIN-TSUNG HUANG, TAINAN CITY (TW)

(21) Appl. No.: 18/451,249

(22) Filed: Aug. 17, 2023

(51) Int. Cl. G02C 5/22; G02C 5/00

(52) U.S. Cl. CPC G02C 5/2263; G02C 5/008

(57) ABSTRACT

A lightweight industrial eyeglass structure includes: a lens, whose two lateral ends are each provided with a protective plate that includes a first pivot member raised form its inner surface; and two temples, each having one end extended with two second pivot members that are spaced vertically and aligned with each other. After the second pivot members and the first pivot member are connected, they are all hidden at the inner surface of the protective plate. The resulting eyeglasses have a weight down to 12˜13 grams, much lighter than typical industrial eyeglasses, which are usually weighted as about 24 grams, and also lighter than the lightest existing eyeglasses, which are reported to be weighted as 16 grams. The structure not only meets industrial safety laws and regulations, but also reduces the overall use amount of plastics of the eyeglasses.

### BACKGROUND OF THE INVENTION

### 1. Technical Field

The present invention relates to an industrial eyeglass structure that is made lightweight without scarifying the overall strength, and is desirable in terms of reduction of carbon emission.

### 2. Description of Related Art

Existing industrial eyeglasses are weighted 24 grams in average, and the lightest eyeglasses currently in the world have a weight of about 16 grams. Due to structures of the known products, further reduction of their weights tends to decrease structural strength of eyeglasses, leading to inconformity of industrial safety laws and regulations, high risks of damage and breakage even under minor impact. Briefly, tradeoff between lightness in weight and structural strength is a choice to be made by eyeglass manufacturers. Besides, the technical limit in further reducing weights of eyeglasses means that the use amounts of plastics cannot be further reduced. Currently, “reducing use of plastics” has become a common goal of governments all around the world and most enterprises and represents an effective means to reduce carbon emission. Hence, to meet such a worldwide trend, it is more important than ever to lighten eyeglasses and reduce use of plastics, thereby adhering plastic-reduction policies and supporting environmental protection.

An example of existing structures of eyeglasses may be Taiwan Utility Model No. M396971 published on Jan. 21, 2011 has disclosed an eyeglass retracting structure. Therien, the frame is provided with chamfered-edge through holes at inner layers of two sides thereof. The adjacent sides of the through holes are each formed with inward extending and expanding space. In the upper part of the space, plural teeth are formed. A boss extends outward from the pivot portion of the temple and is formed with a dome top and notches. The boss can be elastically inserted into the through of the frame. The boss has its upper rim formed with a tooth, so that the boss when being inserted into the space within the frame can engage with the teeth at the corresponding portion. The two temples assembled to two sides of the frame have angular adjustability in use, and can be retracted downward and received into the frame when not in use.

In the prior-art device, the site where the through hole is formed can move toward the center of the lens for a certain range, and the boss of the temple is fittingly received in the through hole. With a decorative plate raised at the rim of the through of the lens, the through hole can be hidden from the outside, thereby enhancing esthetics. However, the decorative plate is incapable of protecting the boss from coming off from the through hole or breakage during impact. Besides, such a design of the decorative plate provides no benefits about reduction of the weight of the eyeglasses.

As another example of known structures, Taiwan Utility Model No. M570962 published on Dec. 1, 2018 has disclosed an eyeglass structure that comprises a base, two snapping units connected to left and right sides of the base, and two temples to be assembled to the snapping units, respectively. Each of the snapping units comprises two extending members that are spaced vertically and extend backward from the base, and a snapping shaft connected to the extending members. Each of the temples includes a connecting member for hooking a snapping unit, and an abutting member spaced from the connecting member horizontally. Each of the connecting members has a forward extending connecting portion, and a shaft-receiving portion extending backward in a hooked pattern from the connecting portion. Every connecting member and the corresponding abutting member work together to define a shaft-receiving recess for recessing the snapping shaft. Every snapping shaft pushes the abutting member toward the corresponding connecting portion, and is received in the corresponding shaft-receiving recess, so that the temples are pivotally connected to the left and right sides of the base.

While the prior document has disclosed a curved portion on the temple close to the connecting portion, the curved portion is merely a necessary structure to enable rotatable combination between the snapping shaft and the shaft-receiving recess and facility assembly between the lens and the temples. The prior-art structure provides no benefits about hand grasping.

### SUMMARY OF THE INVENTION

In view of the issue of existing industrial eyeglasses about tradeoff between lightness in weight and structural strength, the present invention provides a lightweight industrial eyeglass structure, which comprises: a lens, having each of two lateral ends thereof provided with a protective plate, and the protective plate having an inner surface from which a first pivot member is raised, so that the first pivot member is hidden at the inner surface of the protective plate; and two temples, pivotally connected to the two protective plates of the lens, respectively, the temple having one end extended with two second pivot members that are spaced vertically and aligned with each other, so that after the two second pivot members and the first pivot member are connected, the second pivot members are also hidden at the inner surface of the protective plate, and the temple being connected to the two second pivot members by a lug portion bulging outward.

The lens and the two temples when being assembled have a combined weight of between 12 grams and 13 grams.

The lens is made of a high-viscosity shatter-resistant polycarbonate material.

The temples are made of a high-viscosity shatter-resistant polycarbonate material.

The first pivot member is formed with a vertically extending through hole, and a mouth is formed between the two second pivot members, so that the first pivot member is fittingly received and retained in the mouth, in which the two second pivot members have opposite surfaces thereof each formed with a boss, and the two bosses are fittingly received and retained in the through hole.

The mouth has an opening smaller than a thickness of the first pivot member in size, and the first pivot member further has upper and lower sides thereof each provided with a guiding slope which extends from an end of the first pivot member away from the lens to the through hole.

The protective plate has two spaced retaining members provided at the inner surface corresponding to upper and lower sides of the first pivot member, respectively, and thereby a receiving compartment is formed between each of the two retaining members and the first pivot member, so that the two second pivot members are movably fit in the two receiving compartments.

The temple has an opposite end formed as a clasping end, so that the temple, the second pivot members, and the clasping end define a radian fitting a human face.

The lug portion stands out of the radian and forms a curved section on the temple.

The curved section is shaped according to human fingers.

The foregoing technical features of the present invention have the following advantages:

1. Since the lens and the two temples are all made of a high-viscosity shatter-resistant polycarbonate material, the use amount of plastic can be reduced while ensuring good structural strength. Moreover, since the assembled eyeglasses contain no screws, the overall weight of the eyeglasses can be further reduced.

2. The assembled eyeglasses was measured to be of merely 12 grams to 13 grams, much lighter than typical industrial eyeglasses, which are usually weighted as about 24 grams, and also lighter than the lightest existing eyeglasses, which are reported to be weighted as 16 grams. The extremely light eyeglasses of the present invention not only well meet industrial safety laws and regulations, but also significantly reduce use of plastics. This in turn reduces the risk that plasticizers in plastics and the so-called environmental hormones enter human bodies and incur hormonal impact or undermine and interfere balance and functions of the endocrine system to damage human growth, development, and reproductive capacity. Therefore, reduction of use of plastics is good to human health.

3. Additionally, after the first pivot member is connected with the two second pivot members, the parts are hidden at the inner surface of the protective plate. At this time, even the eyeglass structure receives any impact, the impact force can be absorbed and dispersed by the protective plate. This prevents the first pivot member and the two second pivot member from separation or breakage, and thereby ensures safety of the industrial eyeglasses in use.

4. The temple, the second pivot members, and the clasping end jointly define a radian fitting a user's face, with the lug portion bulging out from the radian to form a curved section on the temple. The bulging lug portion connected between the temple and the two second pivot members forms a curved section on the temple standing out of the radian, and the curved section is designed for easy grasping of fingers, so a user can easily and firmly hold the eyeglasses by holding the lug portion with his/her fingers without awkwardness and risks of damage caused by accidental drop.

### BRIEF DESCRIPTION OF THE DRAWINGS

FIG. 1 is an exploded view of one embodiment of the present invention.

FIG. 2 is a perspective view of the embodiment of the present invention.

FIG. 3 is a zoom-in view of Part III in FIG. 1.

FIG. 4, according to the embodiment of the present invention, shows the temple, the second pivot member, and the clasping end defining a radian fitting a user's face.

FIG. 5 is a cross-sectional view taken along Line V-V in FIG. 2.

FIG. 6 is an applied view of the embodiment of the present invention embodiment, showing a user's fingers hold the temple at the lug portion.

### DETAILED DESCRIPTION OF THE INVENTION

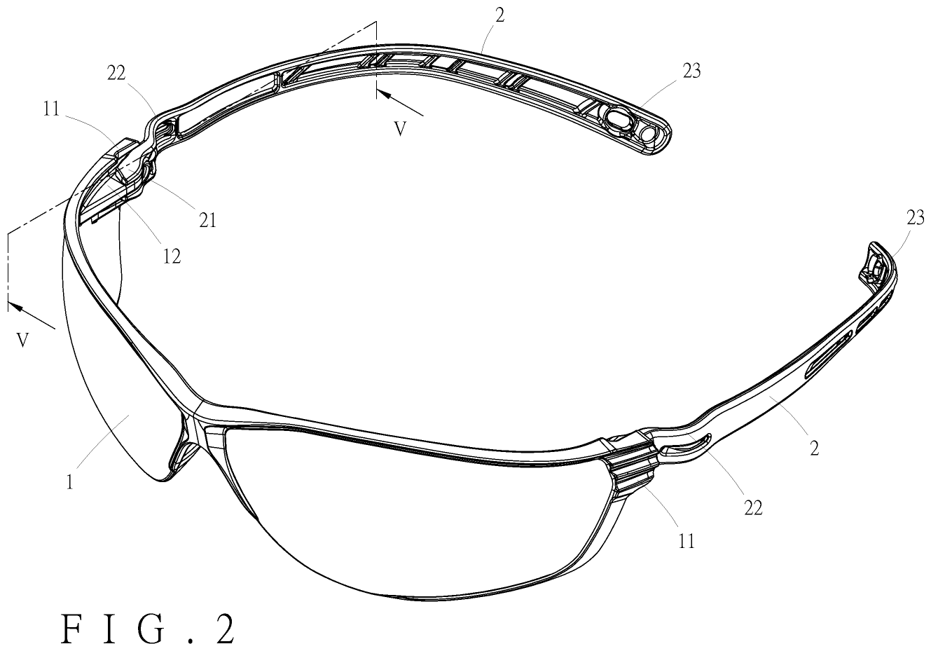

It is to be noted that spatial descriptions, such as “left,” “right,” “front,” “back,” “up,” “down,” and so forth, as used to describe elements in the embodiments of the present invention are based on the directions the eyeglasses (referring to FIG. 2) itself faces, and form no limitations to the spatial aspects of the present invention.

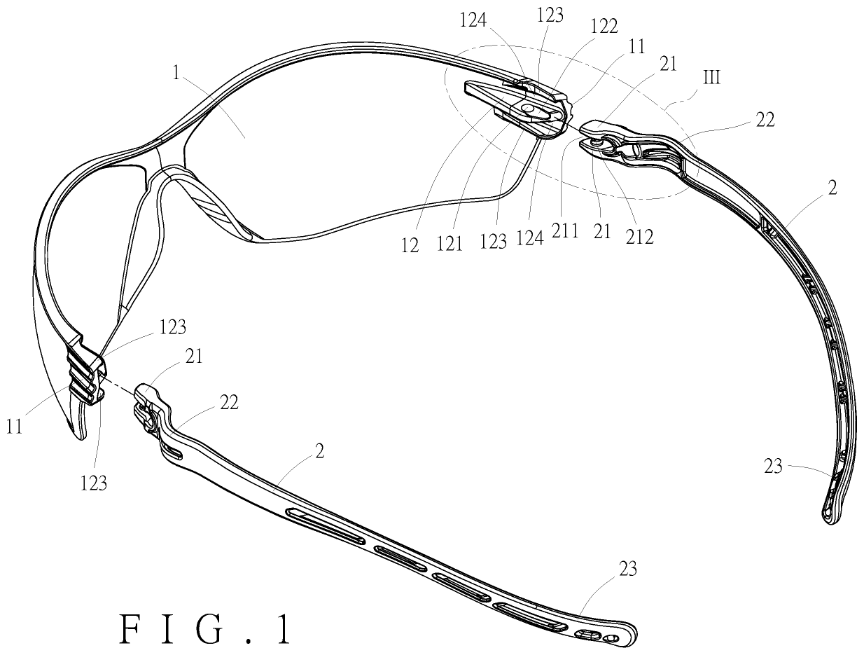

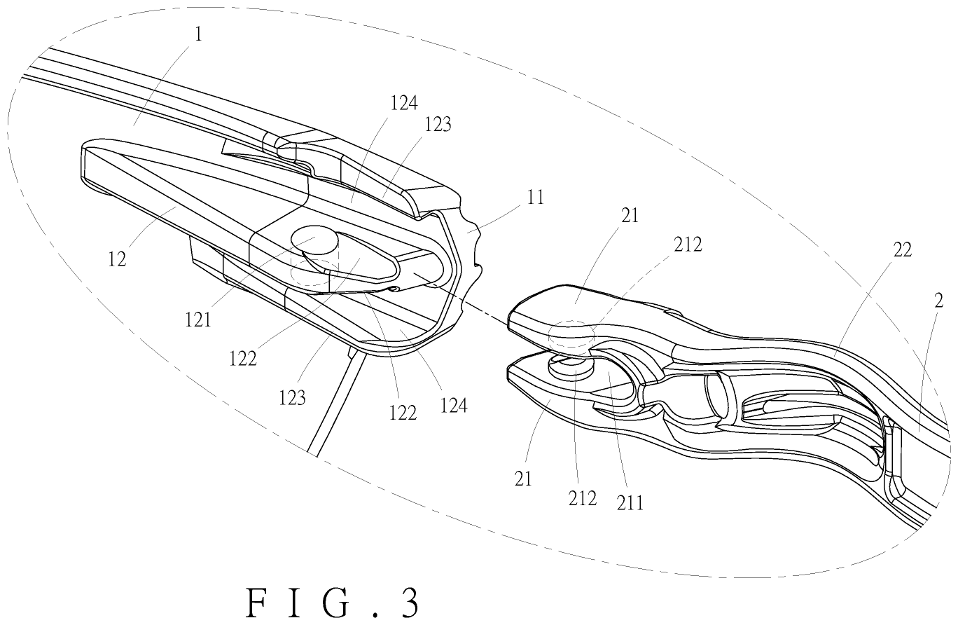

Referring to FIG. 1, FIG. 2, and FIG. 3, the depicted embodiment of the present invention comprises: a lens 1 and temples 2.

The lens 1 is made of a high-viscosity shatter-resistant polycarbonate (PC) material. The lens 1 has each of its two lateral ends provided with a protective plate 11. The protective plate 11 has a first pivot member 12 raised from its inner surface. The first pivot member 12 is such built that it can move toward the center of the lens 1 for a certain range, so as to be hidden at the inner surface of the protective plate 11. The first pivot member 12 has a vertical through hole 121. The first pivot member 12 further has its upper and lower sides each provided with a guiding slope 122 which extends from its end away from the lens 1 to the through hole 121. Moreover, the protective plate 11 has two spaced retaining members 123 provided at its inner surface corresponding to the upper and lower sides of the first pivot member 12, respectively, so that a receiving compartment 124 is formed between each of the two retaining members 123 and the first pivot member 12.

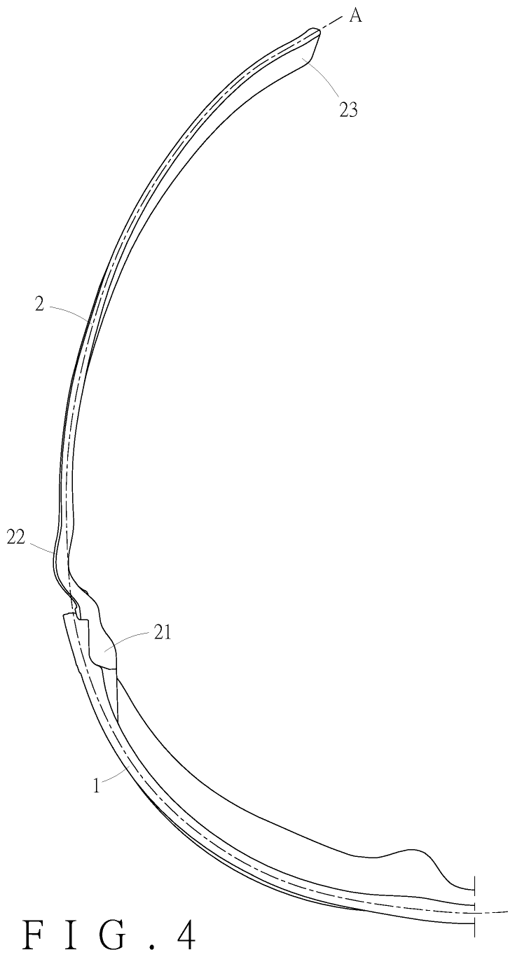

The two temples 2 are pivotally connected to the protective plates 11 at the two lateral ends of the lens 1, respectively, and are also made of the high-viscosity shatter-resistant PC material. Each of the temples 2 has one end extended with two second pivot members 21 that are vertically spaced and aligned with each other. The two second pivot members 21 are pivotally connected to the corresponding first pivot members 12. The two second pivot members 21 are also hidden at the inner surface of the protective plate 11. A mouth 211 is formed between the two second pivot members 21 and has an opening slightly smaller than the thickness of the first pivot member 12 in size. The two second pivot members 21 have their opposite surfaces each formed with a boss 212. Additionally, a lug portion 22 is located between the two second pivot members 21 and the temple 2. The temple 2 has its opposite end formed with a clasping end 23 so that when the lens is put on a user's face, the two clasping ends 23 hold the user's head behind the user's ears. The temple 2, the second pivot members 21, and the clasping end 23 jointly define a radian A fitting the user's face (as shown in FIG. 4), with the lug portion 22 bulging out from the radian A to form a curved section on the temple 2.

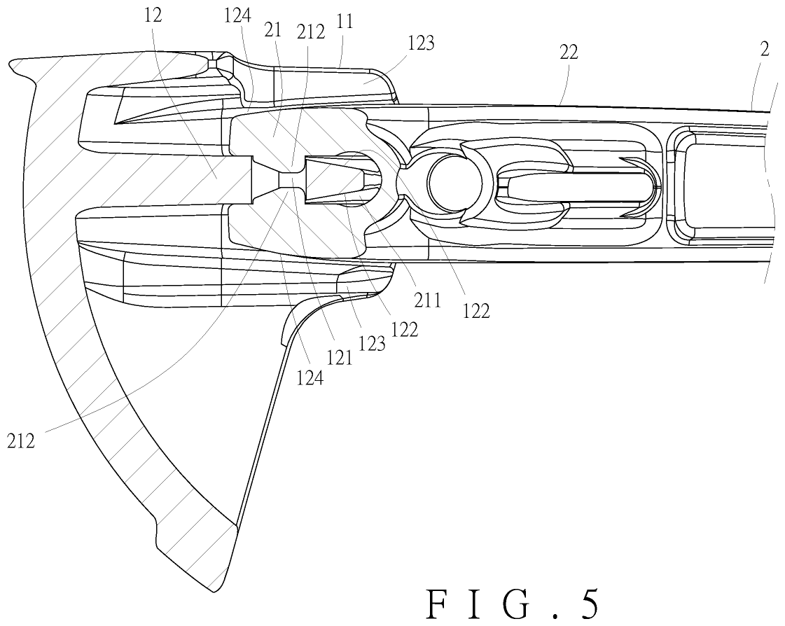

To assemble the eyeglasses, as shown in FIG. 1, FIG. 2, and FIG. 3, the two second pivot members 21 of the temple 2 are aligned with the two receiving compartments 124 formed between the two retaining members 123 and the first pivot member 12, and the first pivot member 12 is aligned with the mouth 211 formed between the two second pivot members 21. Afterward, the temple 2 is pushed toward the lens 1 to make the two bosses 212 move along the guiding slopes 122 toward the through hole 121, so that the first pivot member 12 widens the mouth 211. When the two bosses 212 slide to the edge of the through hole 121, a further pushing force can force the bosses 212 between the two second pivot members 21 into and to be retained by the through hole 121 of the first pivot member 12, as shown in FIG. 5. Meanwhile, the two second pivot members 21 are movably retained in the two receiving compartments 124. Thereby, the two temples 2 are pivotally connected to the two lateral ends of the lens 1 to form the disclosed industrial eyeglasses.

Referring FIG. 1, FIG. 2, and FIG. 4, when a user wears the eyeglasses, the radian A defined by the temple 2, the second pivot member 21, and the clasping end 23 allows the two temples 2 to fit the user's face. Additionally, since the first pivot member 12 is close to the center of the lens 1, after being connected with the two second pivot members 21, the first pivot member 12 can be hidden at the inner surface of the protective plate 11. At this time, even the eyeglass structure receives any impact, the impact force can be absorbed and dispersed by the protective plate 11. This prevents the first pivot member 12 and the two second pivot member 21 from separation or breakage, and thereby ensures use safety.

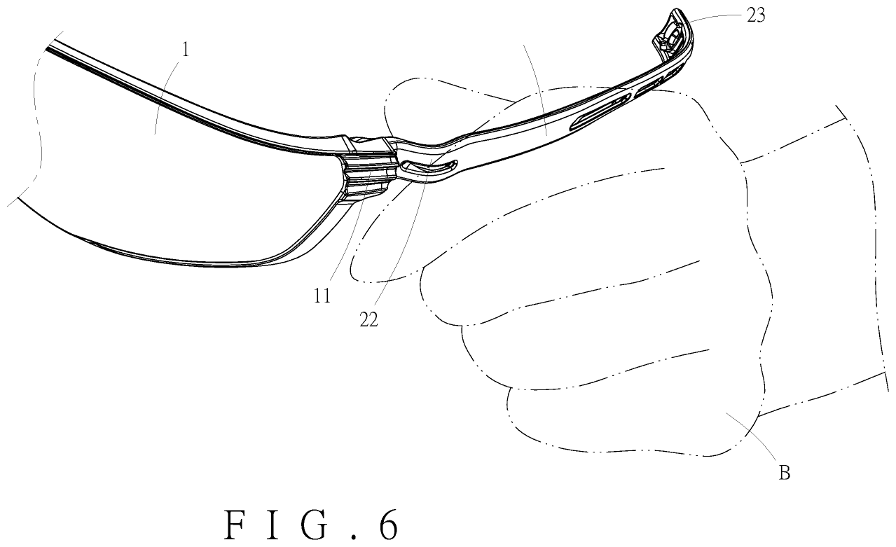

Besides, as shown in FIG. 4 and FIG. 6, the bulging lug portion 22 connected between the temple 2 and the two second pivot members 21 forms a curved section on the temple 2 standing out of the radian A, and the curved section is shaped according to human fingers for easy grasping of a user's fingers B, so a user can easily and firmly hold the eyeglasses by holding the lug portion 22 with his/her fingers B without awkwardness and risks of accidental drop.

As shown in FIG. 1 and FIG. 2, in the present invention, since the lens 1 and the two temples 2 are all made of a high-viscosity shatter-resistant polycarbonate material, the use amount of plastic can be reduced while ensuring good structural strength. Moreover, since the assembled eyeglasses contain no screws, the overall weight of the eyeglasses can be further reduced. In some embodiments, the weight of the assembled eyeglasses is merely of between 12 grams and 13 grams, significantly smaller than that of typical industrial eyeglasses, usually about 24 grams, and also smaller than that of the lightest existing eyeglasses, reported to be 16 grams. The disclosed eyeglass structure uses significantly reduced plastic, so it helps reduce carbon emission during manufacturing and in turn the carbon footprint of the product. The present invention thus helps manufacturers of eyeglasses to fulfill their social responsibility by conforming to regulations for carbon reduction and environmental protection and meeting the global trend of carbon reduction, and to achieved sustainable development and business survival.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A lightweight industrial eyeglass structure, comprising:
a lens, having each of two lateral ends thereof provided with a protective plate, and the protective plate having an inner surface from which a first pivot member is raised, so that the first pivot member is hidden at the inner surface of the protective plate; and
two temples, pivotally connected to the two protective plates of the lens, respectively, the temple having one end extended with two second pivot members that are spaced vertically and aligned with each other, so that after the two second pivot members and the first pivot member are connected, the second pivot members are also hidden at the inner surface of the protective plate, and the temple being connected to the two second pivot members by a lug portion bulging outward.

2. The lightweight industrial eyeglass structure of claim 1, wherein the lens and the two temples when being assembled have a combined weight of between 12 grams and 13 grams.

3. The lightweight industrial eyeglass structure of claim 2, wherein the lens is made of a high-viscosity shatter-resistant polycarbonate material.

4. The lightweight industrial eyeglass structure of claim 2, wherein the temples are made of a high-viscosity shatter-resistant polycarbonate material.

5. The lightweight industrial eyeglass structure of claim 1, wherein the first pivot member is formed with a vertically extending through hole, and a mouth is formed between the two second pivot members, so that the first pivot member is fittingly received and retained in the mouth, in which the two second pivot members have opposite surfaces thereof each formed with a boss, and the two bosses are fittingly received and retained in the through hole.

6. The lightweight industrial eyeglass structure of claim 5, wherein the mouth has an opening smaller than a thickness of the first pivot member in size, and the first pivot member further has upper and lower sides thereof each provided with a guiding slope which extends from an end of the first pivot member away from the lens to the through hole.

7. The lightweight industrial eyeglass structure of claim 1, wherein the protective plate has two spaced retaining members provided at the inner surface corresponding to upper and lower sides of the first pivot member, respectively, and thereby a receiving compartment is formed between each of the two retaining members and the first pivot member, so that the two second pivot members are movably fit in the two receiving compartments.

8. The lightweight industrial eyeglass structure of claim 1, wherein the temple has an opposite end formed as a clasping end, so that the temple, the second pivot members, and the clasping end define a radian fitting a human face.

9. The lightweight industrial eyeglass structure of claim 8, wherein the lug portion stands out of the radian and forms a curved section on the temple.

10. The lightweight industrial eyeglass structure of claim 9, wherein the curved section is shaped according to human fingers.
